(19) United States
(12) Patent Application Publication
(10) Pub. No.: US 2014/0095266 A1
(43) Pub. Date: Apr. 3, 2014

(54) SUPPLY CHAIN FINANCIAL ORCHESTRATION SYSTEM WITH CUSTOM QUALIFIER PARAMETERS

(71) Applicant: Oracle International Corporation, Redwood Shores, CA (US)

(72) Inventors: Kalyana Chakravarthy DANDE, Hyderabad (IN); Girish JHA, Hyderabad (IN); Kalyani MANDA, Hyderabad (IN); Chandu CHINTHALA, Narasimharao Palem (IN); Nitish DAVE, Bilaspur (IN)

(73) Assignee: Oracle International Corporation, Redwood Shores, CA (US)

(21) Appl. No.: 14/036,169

(22) Filed: Sep. 25, 2013

Related U.S. Application Data
(60) Provisional application No. 61/707,630, filed on Sep. 28, 2012.

(51) Int. Cl. G06Q 10/06

(52) U.S. Cl. CPC G06Q 10/0637
USPC 705/7.36

(57) ABSTRACT

A system is provided that implements a qualifier. The system selects a qualifier definition that defines the qualifier; where the qualifier definition includes a computer program code definition including one or more conditions. The system further selects a condition from the one or more conditions, where the condition includes a parameter. The system further determines that the parameter is a custom parameter, where a custom parameter indicates that an external computer program is used to generate a value for the custom parameter. The system further invokes the external computer program to generate a value for the custom parameter. The system further evaluates the condition using the generated value. The system further evaluates the qualifier definition using the evaluated condition.

### CROSS-REFERENCE TO RELATED APPLICATIONS

This application claims priority of U.S. Provisional Patent Application Ser. No. 61/707,630, filed on Sep. 28, 2012, the subject matter of which is hereby incorporated by reference.

### FIELD

One embodiment is directed to a computer system, and more particularly, to a computer system that orchestrates supply chain financial processes.

### BACKGROUND

Large multi-national companies, or other enterprises, often operate through a number of subsidiary companies, or other legal entities, spread across the globe. These subsidiary companies can be further divided into business units or lines of businesses. The intersection of each subsidiary company and line of business (identified as a “profit center business unit”) can become a supply chain entity that engages in manufacturing, purchase, and/or sale of goods and services.

The profit center business units typically engage commercially with an external supply chain, such as a collection of suppliers and customers. They can also engage in internal trades, or internal transfers, within the subsidiary company. One example type of an internal trade is an “inter-company trade,” where a profit center business unit belonging to one subsidiary company trades with a profit center business unit belonging to another subsidiary company, at arm's length terms and conditions. Another example type of an internal trade is an “intra-company trade,” where two profit center business units belonging to the same subsidiary company trade among each other on a competitive basis. Companies typically need to identify financial routes for their internal trades/transfers. Further, to support customized trades/transfers, companies also typically require flexibility to use their own information sources to identify a financial route.

### SUMMARY

One embodiment is a system that implements a qualifier. The system selects a qualifier definition that defines the qualifier; where the qualifier definition includes a computer program code definition including one or more conditions. The system further selects a condition from one or more conditions, where the condition includes a parameter. The system further determines that the parameter is a custom parameter, where a custom parameter indicates that an external computer program is used to generate a value for the custom parameter. The system further invokes the external computer program to generate a value for the custom parameter. The system further evaluates the condition using the generated value. The system further evaluates the qualifier definition using the evaluated condition.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates an example supply chain financial orchestration flow, according to an embodiment of the invention.

FIG. 3 illustrates a block diagram of an example architecture of a supply chain financial orchestration system, according to an embodiment of the invention.

FIG. 4 illustrates an example user interface for defining a qualifier, according to an embodiment of the invention.

FIG. 5 illustrates an example user interface for defining a qualifier with a custom parameter, according to an embodiment of the invention.

FIG. 6 illustrates a flow diagram of the functionality of a supply chain financial orchestration qualifier module, according to an embodiment of the invention.

### DETAILED DESCRIPTION

According to an embodiment, a supply chain financial orchestration system is provided that can provide one or more qualifier rules (i.e., “qualifiers”), where the qualifiers can be user-defined qualifiers. A qualifier is a rule for determining an applicability of a supply chain financial orchestration flow, where a supply chain financial orchestration flow defines a trade relationship between a first entity and a second entity. More specifically, a qualifier can be used to determine whether a supply chain financial orchestration flow is applicable to a transaction or source document. The qualifier can include a number of conditions. If a sufficient amount of conditions of the qualifier are met, then the supply chain financial orchestration flow is applicable to the transaction or source document. If a sufficient amount of conditions of the qualifier are not met, then the supply chain financial orchestration flow is not applicable to the transaction or source document. One or more qualifiers can be defined as part of (i.e., associated with) a supply chain financial orchestration flow. A qualifier can invoke an external user-defined computer program to generate a value for a parameter for one or more conditions of the qualifier. The external user-defined computer program can be registered and stored within a definition of the qualifier for invocation at run-time during evaluation of the one or more conditions of the qualifier.

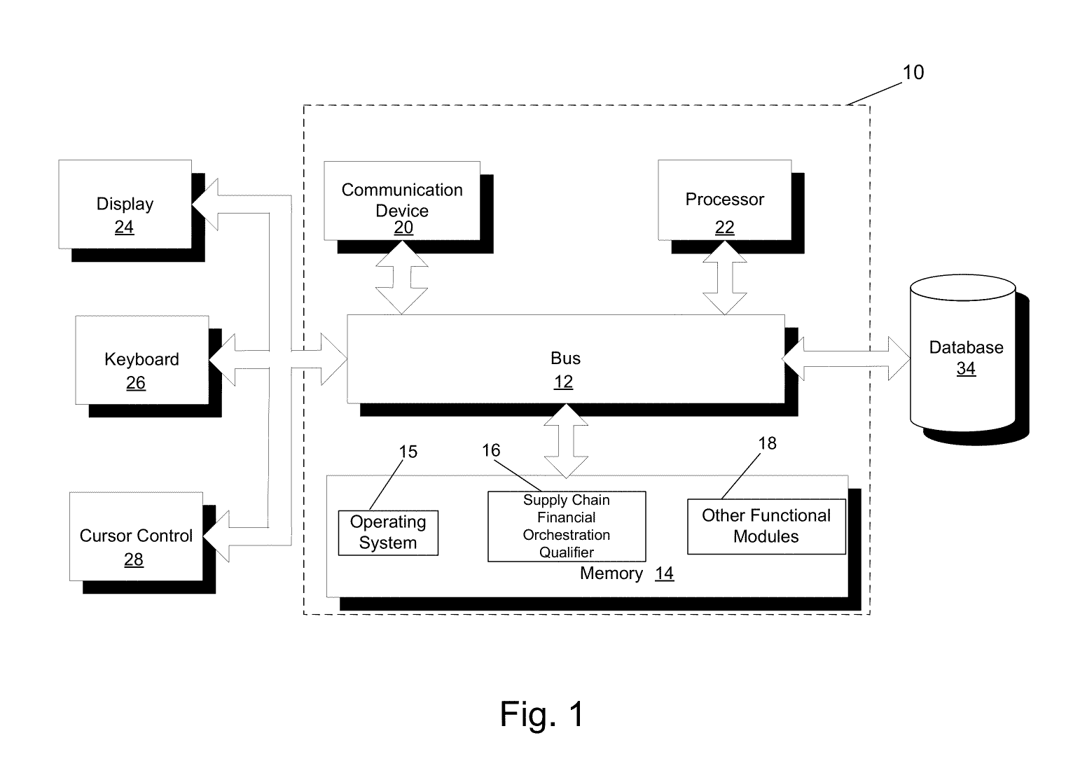

FIG. 1 illustrates a block diagram of a supply chain financial orchestration system 10 that may implement one embodiment of the invention. Supply chain financial orchestration system 10 includes a bus 12 or other communications mechanism for communicating information between components of supply chain financial orchestration system 10. Supply chain financial orchestration system 10 also includes a processor 22, operatively coupled to bus 12, for processing information and executing instructions or operations. Processor 22 may be any type of general or specific purpose processor. Supply chain financial orchestration system 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. Supply chain financial orchestration system 10 further includes a communication device 20, such as a network interface card or other communications interface, to provide access to a network. As a result, a user may interface with supply chain financial orchestration system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with supply chain financial orchestration system 10.

According to one embodiment, memory 14 can store software modules that may provide functionality when executed by processor 22. The modules can include an operating system 15, a supply chain financial orchestration qualifier module 16, as well as other functional modules 18. Operating system 15 can provide an operating system functionality for supply chain financial orchestration system 10. Supply chain financial orchestration qualifier module 16 can provide functionality for defining and evaluating qualifiers with at least one custom parameter, as is described in more detail below. In certain embodiments, supply chain financial orchestration qualifier module 16 can comprise a plurality of modules that each provide specific individual functionality for defining and evaluating qualifiers with at least one custom parameter. Supply chain financial orchestration system 10 can also be part of a larger system. Thus, supply chain financial orchestration system 10 can include one or more additional functional modules 18 to include the additional functionality. For example, functional modules 18 may include modules that provide additional functionality, such as an “Oracle Fusion Applications” product from Oracle Corporation. In another example, functional modules 18 may include enterprise resource planning (“ERP”) modules of an ERP system, where an ERP system is a computer system that integrates several data sources and processes of an organization into a unified system.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

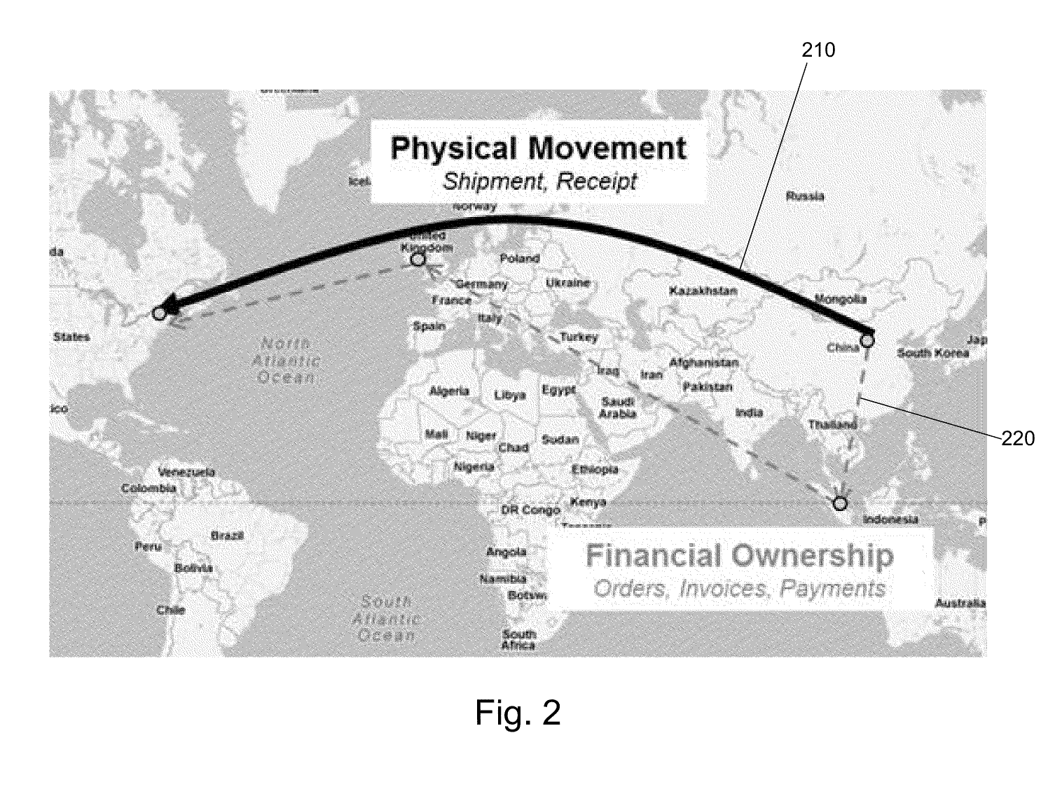

FIG. 2 illustrates an example supply chain financial orchestration flow, according to an embodiment of the invention. The supply chain financial orchestration flow is between a shipping entity in China and a receiving entity in the United States. As illustrated in FIG. 2, the supply chain financial orchestration flow includes a physical movement flow 210 and a financial flow 220. Physical movement flow 210 represents the physical movement of items from the shipping entity in China, to the receiving entity in the United States, and can involve the physical movement through one or more intermediate entities. Physical movement flow 210 can include one or more physical transactions that are executed in association with the physical movement of the items (such as shipments, receipts, etc.). Financial flow 220 represents the change in financial ownership of items from the shipping entity in China, to the receiving entity in the United States, and can involve the change in financial ownership of one or more intermediate entities. Financial flow 220 can include one or more financial transactions that are executed in associate with the change in financial ownership of the items (such as orders, invoices, payments, etc.). As illustrated in FIG. 2, a physical movement flow can be separate and independent of a financial flow within a supply chain financial orchestration system.

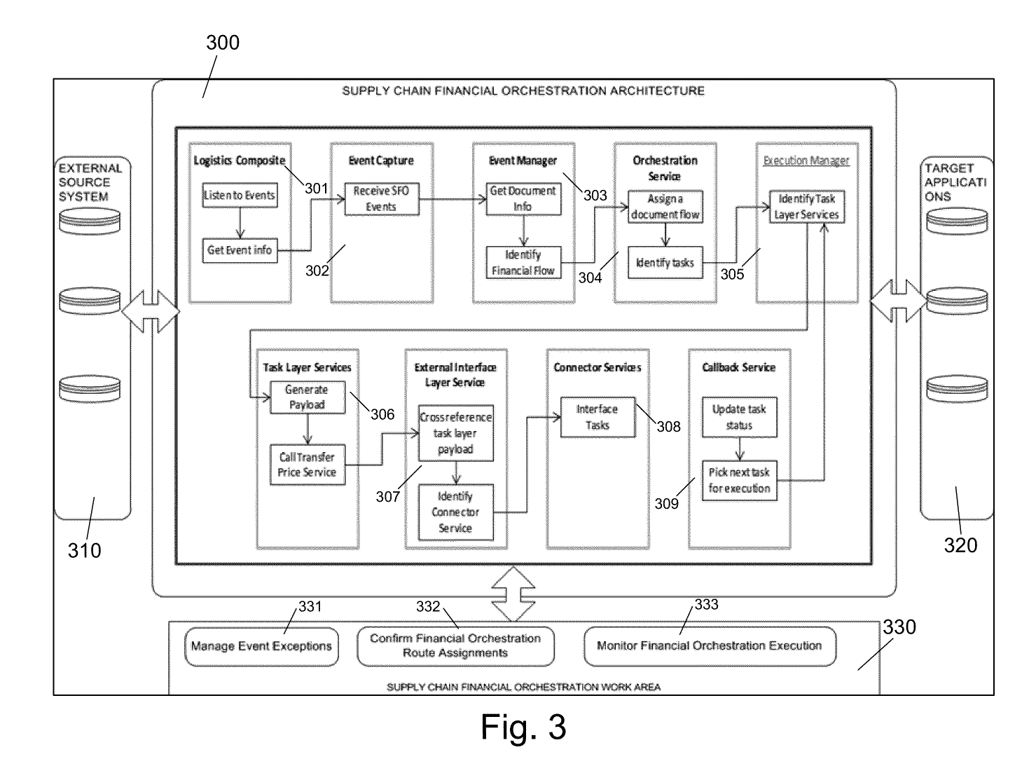

FIG. 3 illustrates a block diagram of an example architecture of a supply chain financial orchestration system 300, according to an embodiment of the invention. According to the embodiment, supply chain financial orchestration system 300 is a configurable system that manages internal trade relationships between entities belonging to an enterprise, where the enterprise is typically spread across geographies. Supply chain financial orchestration system 300 can define a nature of trade relationships, business rules, internal controls, regulatory compliances, and other terms and conditions required to execute, monitor, and evaluate trade transactions emanating out of such relationships. More specifically, supply chain financial orchestration system 300 can listen to events that occur in supply chain transactions in various external source systems, and can identify internal transactions (such as inter-company transactions and intra-company transactions) based on pre-defined trade relationships. Once the internal transactions are identified, supply chain financial orchestration system 300 can create necessary accounting and documentations required to be generated for the internal transactions according to the business rules defined in supply chain financial orchestration system 300.

According to the illustrated embodiment, supply chain financial orchestration system 300 includes event mediator 301, event capture 302, event manager 303, orchestration service 304, execution manager 305, task layer service 306, external interface layer service 307, connector service 308, and callback service 309. Event mediator 301 listens for events generated by an external source system (i.e., application) of external source systems (i.e., applications) 310. If an event is of interest to supply chain financial orchestration system 300, event mediator 301 can also call a web service exposed by the external source system of external source systems 310 to enrich the event details. Event mediator 301 then sends the event to event capture 302. Event capture 302 validates the event details retrieved after enrichment, and stores the event in an external source system format.

Subsequently, event manager 303 identifies a source document enrichment web service based on a source order type, and calls the source document enrichment web service for enrichment. The source document enrichment service is exposed by an external source system of external source systems 310 where the source order originated. Event manager 303 can pass a source document identifier as an input parameter to the enrichment web service and can retrieve the source document information, where a source document identifier is a unique identifier of the source document that is communicated to the external source system of external source systems 310. The external source system of external source systems 310 that is responsible for capturing the physical transaction can be responsible for passing the source document identifier as part of event information. Supply chain financial orchestration system 300 can maintain an association between a supply chain event and a source document type. Event manager 303 can further transform the source document information into a format that is understandable by supply chain financial orchestration system 300, and can identify a supply chain financial orchestration flow based on qualifiers, source document type, physical route, parties involved in an internal trade, and a priority of the supply chain financial orchestration flow. Further, a supply chain financial orchestration flow can be date effective. This means that any modification to a supply chain financial orchestration flow can cause a new effective date to be associated with the supply chain financial orchestration flow. Thus, transactions pertaining to a source document created before the effective date of the modification can be associated with the original supply chain financial orchestration flow, and transactions pertaining to a source document created after the effective date of the modification can be associated with the modified supply chain financial orchestration flow.

Orchestration service 304 verifies whether a supply chain financial orchestration flow is already assigned to a source document or not. If the supply chain financial orchestration flow is not already assigned, orchestration service 304 can assign the supply chain financial orchestration flow to the source document, and can generate the tasks that are to be performed between internal entities based on the documentation and accounting rules setup for the supply chain financial orchestration flow (such as a global procurement flow, a customer shipment flow, and an internal transfer flow). A global procurement flow is a supply chain financial orchestration flow where a central buying entity buys goods from suppliers on behalf of one or more internal entities. The supplier liability is borne by the purchasing entity. The purchasing and requesting entity settle the transaction among themselves using a transfer price (sometimes through one or more intermediary entities). A customer shipment flow is a supply chain financial orchestration flow in which a selling business unit is different from a profit center business unit of the entity that owns and ships the goods. The selling entity receives an order from a customer, and the shipping entity ships the goods directly to the customer. The shipping entity is settled financially by the selling entity (sometimes through one or more intermediary entities). A customer shipment flow can be an internal drop shipment flow, which is a forward customer shipment flow, or a customer drop shipment flow, or a return customer shipment flow. An internal transfer flow is a supply chain financial orchestration flow in which physical movement of goods happens between internal entities. The internal entities settle the financial transactions among themselves using a transfer price.

The tasks that are to be performed can be specific to a forward flow and a return flow for the supply chain financial orchestration flow. A forward flow is a flow of events that proceeds in a specific direction (such as from a supplier entity to a purchaser entity), and a return flow is a flow of events that proceeds in a reverse direction (such as from a purchaser entity to a supplier entity). In addition to ownership transfer between internal entities, events indicating ownership transfer from a supplier entity to a purchasing entity can also be setup in a supply chain financial orchestration flow definition. When an event designated as a supplier ownership change event occurs, orchestration service 304 can generate the tasks for creating trade distributions to book supplier accrual and costs in a costing system, as well. Execution manager 305 invokes a task layer service based on a task type. Generally, the tasks are performed in a defined sequence, and if there is any dependency from a previous task, execution manager 305 can wait for the previous task to complete. Example task types can include inter-company trade documents (e.g., purchase order and sales order), trade distribution tasks related to costing, inter-company receivable invoices related to inter-company receivable, payables invoice, or credit memo tasks that are set in documentation and accounting rules. Task types can also include user-defined tasks.

Task layer service 306 creates a task layer service payload. Task layer service 306 can include logic to populate the payload data depending on a global procurement flow, a customer shipment flow, or an internal transfer flow. Task layer service 306 can also call a transfer price service to get a transfer price, where the transfer price is a price in which a selling entity sells goods to a purchasing entity, where the selling entity and the purchasing entity are involved in an internal trade. External interface layer service 307 identifies a target system (i.e., application) of target systems (i.e., applications) 320, and obtains a connector service (e.g., connector service 308) for the target system of target systems 320 based on the task type. Connector service 308 transforms the task layer service payload into a format which is understandable by the target system of target systems 320. Once the task data is transformed according to a target system format, connector service 308 calls a web service to interface tasks in interface tables of the target system of target systems 320. Callback service 309 receives responses from the target system of target systems 320 and updates the task status. If the task is a last task in a sequence, then the supply chain financial orchestration is complete. Otherwise, the next task in the sequence is selected, and execution manager 305 is invoked with the task type.

Supply chain financial orchestration system 300 further includes a supply chain financial orchestration work area 330 that includes a plurality of user interfaces that allow a user to interact with supply chain financial orchestration system 300. Supply chain financial orchestration work area 330 includes manage event exceptions 331, confirm financial orchestration route assignments 332, and monitor financial orchestration execution 333. Manage event exceptions 331 is a user interface that allows users to view, troubleshoot, and manage events which faulted due to a setup or technical reason. Confirm financial orchestration route assignments 332 is a user interface that allows a user to confirm a supply chain financial orchestration flow before the tasks of the supply chain financial orchestration flow are initiated by orchestration service 304. Monitor financial orchestration execution 333 is a user interface that allows user to monitor supply chain financial orchestration flows that are in progress, that have not started, and that have completed.

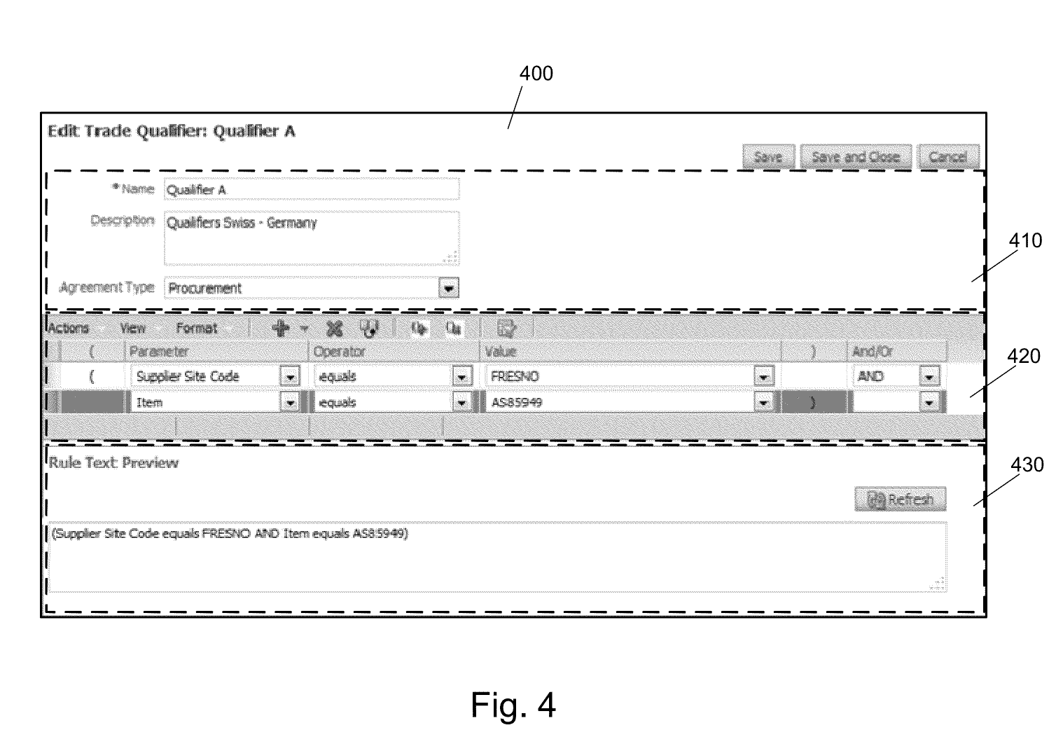

FIG. 4 illustrates an example user interface 400 for defining a qualifier, according to an embodiment of the invention. As previously described, a qualifier is a rule for determining an applicability of a supply chain financial orchestration flow. More specifically, a qualifier can be used to determine whether a supply chain financial orchestration flow is applicable to a transaction or source document. The qualifier can include a computer program definition, where the computer program definition includes a specific number of conditions. When the qualifier is executed and applied against a transaction or source document, the conditions included within the computer program definition are evaluated using parameter values from the transaction or source document. If a sufficient amount of conditions of the qualifier are met, then the supply chain financial orchestration flow is applicable to the transaction or source document. If a sufficient amount of conditions of the qualifier are not met, then the supply chain financial orchestration flow is not applicable to the transaction or source document. Further, applicable attributes of a supply chain financial orchestration flow that are defined within a qualifier depend on a supply chain financial orchestration flow type (i.e., business process type). As previously described, example supply chain financial orchestration flow types include a global procurement flow, a customer shipment flow, and an internal transfer flow. Thus, user interface 400 can display a qualifier definition, where the qualifier definition defines the qualifier.

According to the embodiment, user interface 400 includes qualifier details window 410. Qualifier details window 410 displays details of the displayed qualifier, such as name, description, and supply chain financial orchestration flow type (identified in FIG. 4 as “agreement type”). A name can define a name of the qualifier. In the illustrated embodiment, the name of the qualifier displayed within user interface 400 is “Qualifier A.” A description can define a description of the qualifier. In the illustrated embodiment, the description of the qualifier displayed within user interface 400 is “Qualifiers Swiss—Germany.” A supply chain financial orchestration flow type can define a type of supply chain financial orchestration flow that the qualifier can be associated with, and further defines the parameters that can be displayed within qualifier conditions window 420, described below in greater detail. In the illustrated embodiment, the supply chain financial orchestration flow type of the qualifier displayed within user interface 400 is a global procurement flow.

User interface 400 further includes qualifier conditions window 420. Qualifier conditions window 420 displays one or more conditions for determining an applicability of a supply chain financial orchestration flow. Each condition can include a parameter, a value, an operator, and an “and/or” indicator. A parameter can define an attribute of either a transaction or a source document. A value can define a value for the parameter. An operator can define a relationship between the parameter and the value. Example operators include “equals” and “does not equals.” An “and/or” indicator can define either a logical conjunction of two conditions (e.g., “condition 1 AND condition 2” evaluates to true when both condition 1 and condition 2 are true) or a logical disjunction of two conditions (e.g., “condition 10R condition 2” evaluates to true when condition 1 is true, or condition 2 is true, or both condition 1 and condition 2 are true).

User interface 400 further includes qualifier rule text preview window 430. Qualifier rule text preview window 430 displays a preview of a text representation of the qualifier, which includes the one or more conditions of the qualifier. In the illustrated embodiment, the qualifier can determine whether a supplier site code parameter is equal to “FRESNO,” and whether an item parameter is equal to “AS85949.” Based on these determinations, the qualifier can determine whether the supply chain financial orchestration flow is applicable to the transaction or source document.

Thus, according to the illustrated embodiment, an example qualifier definition is provided that includes two conditions, where the qualifier definition is displayed within user interface 400. The qualifier definition is applicable to global procurement flows. Each condition of the qualifier definition is evaluated at run-time to “TRUE” or “FALSE” by applying an operator of the condition between the data defined for a value of the condition and a run-time value of a parameter of the condition. For example, the first condition of the qualifier definition displayed within user interface 400 is substituted with a run-time value of a supplier site code parameter, where the run-time value is equated with the value, “FRESNO.” If the run-time value of the supplier site code parameter is “FRESNO,” then the condition evaluates to “TRUE.” If the run-time value of the supplier site code parameter is not “FRESNO,” then the condition evaluates to “FALSE.” Similarly, all conditions of the qualifier definition are evaluated, and a final outcome of “TRUE” or “FALSE” is determined for the qualifier definition.

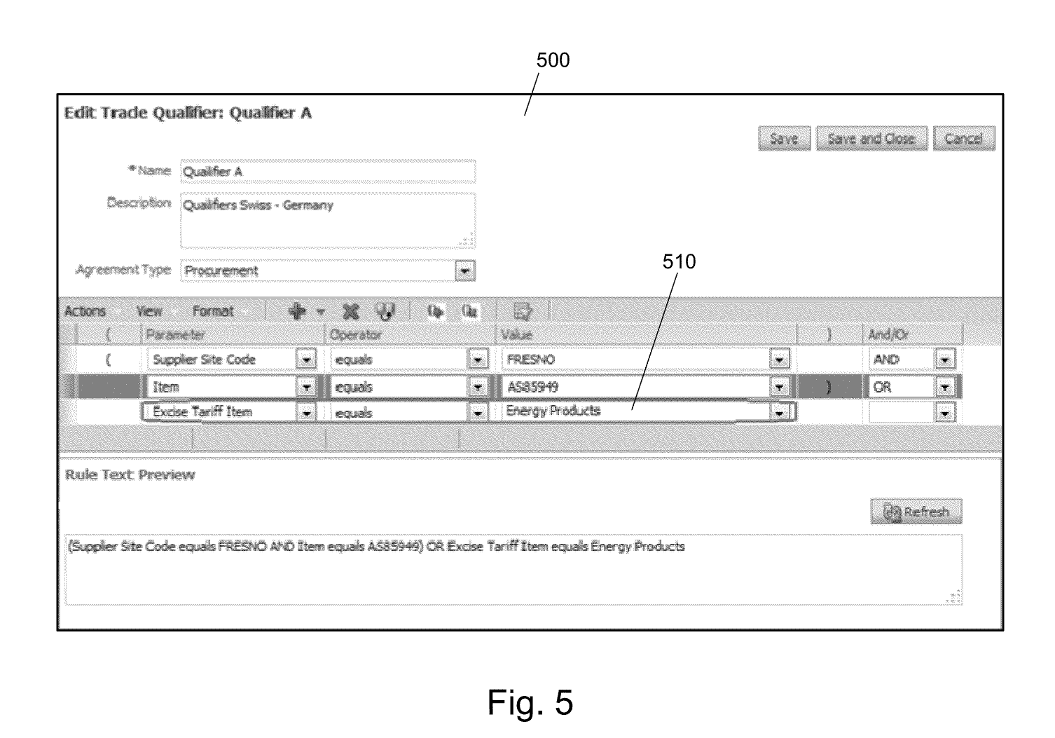

FIG. 5 illustrates an example user interface 500 for defining a qualifier with a custom parameter, according to an embodiment of the invention. As previously described, a qualifier can invoke an external user-defined computer program to generate a value for a parameter for one or more conditions of the qualifier. While a supply chain financial orchestration system allows the user to define qualifiers based on pre-defined parameters in the conditions, a user may require the flexibility of using their own information to identify a supply chain financial orchestration flow. If a supply chain financial orchestration system does not provide user-defined qualifier parameter support, then a user would have to customize a pre-defined computer program definition for a qualifier that is “built-in” within the supply chain financial orchestration system. Such a customization can get overwritten, when the computer program definition is updated, and can lead to increased maintenance overhead. Thus, an external user-defined computer program (such as a procedural language/structured query language (“PL/SQL”) function) can be defined, where the external user-defined computer program can include one or more functions for generating a value for a parameter of a condition. The external user-defined computer program can be registered and stored within a computer program definition of the qualifier for invocation at run-time during evaluation of the one or more conditions of the qualifier.

According to the illustrated embodiment, the qualifier definition displayed within user interface 500 is identical to the qualifier definition displayed within user interface 400 of FIG. 4, except that the qualifier definition displayed within user interface 500 includes a third condition, condition 510. Further, condition 510, includes an excise tariff item parameter, which is an example of a custom parameter. A custom parameter is a parameter that indicates that an external user-defined computer program (e.g., PL/SQL function) is used to generate a value for the custom parameter, rather than retrieving the value from an attribute of either a transaction or a source document. In other words, rather than the qualifier generating the value of the custom parameter by retrieving the value from an attribute of either a transaction or a source document, the qualifier invokes an external user-defined computer program to generate the value for the custom parameter.

A user can register the external user-defined computer program, and the external user-defined computer program can be stored as part of the qualifier definition. Upon run-time, when applying the qualifier displayed within user interface 500, the supply chain financial orchestration system can invoke the external user-defined computer program, which generates the value for the custom parameter, and returns the value to the supply chain financial orchestration system. Thus, in the illustrated embodiment, the external user-defined computer program can be invoked to generate a value for the excise tariff item parameter, the external user-defined computer program can return the generated value to the supply chain financial orchestration system, and the supply chain financial orchestration system can evaluate whether the generated value is equal to “Energy Products.” If the generated value is equal to “Energy Products,” condition 510 can be evaluated to “TRUE.” If the generated value is not equal to “Energy Products,” condition 510 can be evaluated to “FALSE.”

In one embodiment, a user can define the external user-defined computer program by first creating source code for the external user-defined computer program. The custom parameter can be stored within a row of a qualifier definition database table. For example, the custom parameter can be stored within a row of a first qualifier definition database table, FOS_QUALIFIER_DEFINITIONS_B, and within a row of a second qualifier definition database table, FOS_QUALIFIER_DEFINITIONS_TL. Qualifier definition database tables FOS_QUALIFIER_DEFINITIONS_B and FOS_QUALIFIER_DEFINITIONS_TL can include the database columns, GP_QUALIFIER_FLAG, IMT_QUALIFIER_FLAG, SHIPMENT_QUALIFIER_FLAG, and DROP_SHIP_QUALIFIER_FLAG. Each of the database columns can be set to the value “Y” based on the custom parameter's applicability to global procurement flows, internal transfer flows, internal drop shipment flows, or customer drop shipment flows, respectively. Further, the name of the external user-defined computer program can be stored within a database column of the qualifier definition database table, FOS_QUALIFIER_DEFINITIONS_B (e.g., FOS_QUALIFIER_DEFINITIONS_B.CUSTOM_QUALIFIER_HOOK_PROGRAM). The external user-defined computer program referenced within the database column of the qualifier definition database table can include one or more parameters that can retrieve a context of a supply chain financial orchestration flow identification.

At run-time, according to the embodiment, when a condition that includes the custom parameter is evaluated, the external user-defined computer program referenced within the database column of the qualifier definition database table can be invoked to generate the value for the custom parameter. The generated value can then be used to evaluate the condition and to determine the outcome of the condition (e.g., whether the condition evaluates to “TRUE” or “FALSE”). The evaluated condition can then be used to evaluate the overall qualifier, and to determine the outcome of the overall qualifier (e.g., whether the overall qualifier evaluates to “TRUE” or “FALSE”).

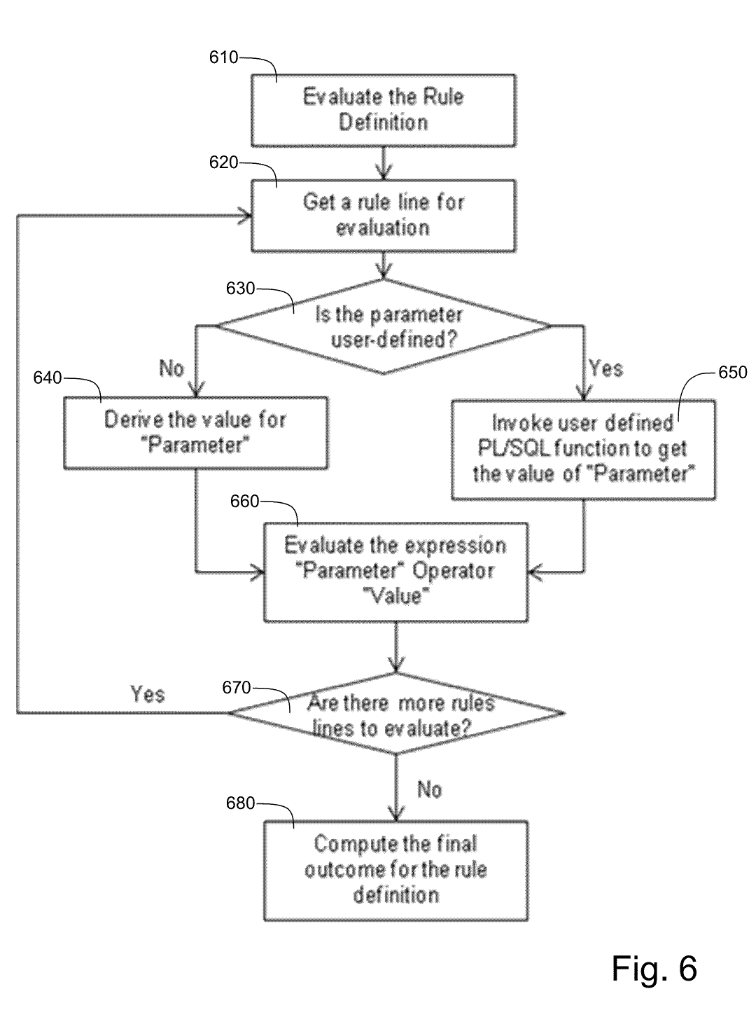

FIG. 6 illustrates a flow diagram of the functionality of a supply chain financial orchestration qualifier module (such as supply chain financial orchestration qualifier module 16 of FIG. 1), according to an embodiment of the invention. In one embodiment, the functionality of the flow diagram of FIG. 6 is implemented by software stored in memory or other computer-readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

The flow begins, and proceeds to 610. At 610, a qualifier definition (identified in FIG. 6 as a “rule definition”) is selected and evaluated. According to the embodiment, a qualifier is associated with a supply chain financial orchestration flow, where a supply chain financial orchestration flow defines a trade relationship between a first entity and a second entity. The qualifier can determine an applicability of the supply chain financial orchestration flow regarding a transaction or a source document. Further, a qualifier definition is a computer-program definition that can include one or more conditions. The qualifier definition can be stored within a qualifier definition table. The flow then proceeds to 620.

At 620, a condition (identified in FIG. 6 as a “rule line”) is selected for evaluation. According to the embodiment, the condition can include a parameter, a condition, and a value. The condition can also include an “and/or” indicator. The flow then proceeds to 630.

At 630, it is determined whether the parameter is a custom parameter (identified in FIG. 6 as a “user-defined” parameter). If the parameter is not a custom parameter, the flow proceeds to 640. If the parameter is a custom parameter, the flow proceeds to 650.

According to the embodiment, a custom parameter indicates that an external user-defined computer program is used to generate value for the custom parameter. The external user-defined computer program can be defined independently from the computer program code definition of the qualifier definition. In an embodiment, the external user-defined computer program can be a PL/SQL function. Further, the external user-defined computer program can include a user-defined function that generates a value for the custom parameter at run-time.

In one embodiment, the external user-defined computer program can be stored within the qualifier definition. More specifically, the external user-defined computer program can be stored within the qualifier definition database table. The external user-defined computer program can be linked with the custom parameter. Further, in one embodiment, the external user-defined computer program can include one or more parameters that retrieve a context of the supply chain financial orchestration flow.

At 640, a value is derived for the parameter. According to an embodiment, the value can be retrieved from a transaction or a source document. The flow then proceeds to 660.

At 650, the external user-defined computer program (identified in FIG. 6 as the “user defined PL/SQL function”) is invoked to generate a value for the custom parameter. The flow then proceeds to 660.

At 660, the condition (identified in FIG. 6 as “‘Parameter’ Operator ‘Value’”) is evaluated using the generated value. According to the embodiment, the generated value can be compared with the value of the condition, and a status value (e.g., “TRUE” or “FALSE”) can be determined for the condition. The flow then proceeds to 670.

At 670, it is determined whether there are any more conditions (identified in FIG. 6 as “rule lines”) to evaluate If there are more conditions to evaluate, the flow returns to 620. Thus, some or all of 620, 630, 640, 650, and 660 can be implemented for the one or more conditions of the qualifier definition that were not selected In certain embodiments, this can involve: determining that a parameter of at least one condition is a separate custom parameter; invoking a separate external user-denied computer program to generate a separate value for the separate custom parameter; and evaluating the condition using the separate generated value.

At 680, a final outcome for the qualifier definition (identified in FIG. 6 as a “rule definition”) is computed. In other words, the qualifier definition is evaluated using the one or more evaluated conditions, and an overall status value of the qualifier definition is generated based on the one or more evaluated conditions. The flow then ends.

Thus, in one embodiment, a supply chain financial orchestration system can allow a user to define an external custom computer program for generating a value, assign the external custom computer program to a custom parameter, and invoke the external custom computer program to generate the value at run-time, as part of a qualifier definition. This can provide for user-defined qualifier parameter support, which can improve flexibility in defining a qualifier to select a supply chain financial orchestration flow, and to reduce maintenance of computer program source code.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to implement a qualifier with at least one custom parameter for a supply chain financial orchestration flow, the implementing comprising:
selecting a qualifier definition that defines the qualifier; wherein the qualifier definition comprises a computer program code definition comprising one or more conditions;
selecting a condition from the one or more conditions, wherein the condition comprises a parameter;
determining that the parameter is a custom parameter, wherein a custom parameter indicates that an external computer program is used to generate a value for the custom parameter;
invoking the external computer program to generate a value for the custom parameter;
evaluating the condition using the generated value; and
evaluating the qualifier definition using the evaluated condition.

2. The computer-readable medium of claim 1,
wherein the external computer program comprises a user-defined computer program; and
wherein the user-defined computer program is defined independently from the computer program code definition of the qualifier definition.

3. The computer-readable medium of claim 2, wherein the user-defined computer program comprises a procedural language/structured query language function.

4. The computer-readable medium of claim 2, wherein the user-defined computer program comprises a user-defined function that generates a value for the custom parameter at run-time.

5. The computer-readable medium of claim 2, the implementing further comprising;
defining the user-defined computer program;
storing a name of the user-defined computer program within the qualifier definition; and
linking the user-defined computer program with the custom parameter.

6. The computer-readable medium of claim 5,
wherein the qualifier definition is stored within a qualifier definition database table; and
wherein the user-defined computer program is stored within the qualifier definition database table.

7. The computer-readable medium of claim 1,
wherein the supply chain financial orchestration flow defines a trade relationship between a first entity and a second entity; and
wherein the qualifier determines an applicability of the supply chain financial orchestration flow.

8. The computer-readable medium of claim 7, wherein the external computer program comprises one or more parameters that retrieve a context of the supply chain financial orchestration flow.

9. The computer-readable medium of claim 1, wherein the evaluating the qualifier definition using the evaluated condition further comprises:
evaluating the one or more conditions of the qualifier definition that were not selected; and
generating an overall status value of the qualifier definition based on the one or more evaluated conditions.

10. The computer-readable medium of claim 9, the implementing further comprising:
determining that a parameter of at least one condition of the one or more conditions that were not selected is a separate custom parameter;
invoking a separate external computer program to generate a separate value for the separate custom parameter; and
evaluating the at least one remaining condition using the separate generated value.

11. A computer-implemented method for implementing a qualifier with at least one custom parameter for a supply chain financial orchestration flow, the computer-implemented method comprising:
selecting a qualifier definition that defines the qualifier; wherein the qualifier definition comprises a computer program code definition comprising one or more conditions;
selecting a condition from the one or more conditions, wherein the condition comprises a parameter;
determining that the parameter is a custom parameter, wherein a custom parameter indicates that an external computer program is used to generate a value for the custom parameter;
invoking the external computer program to generate a value for the custom parameter;
evaluating the condition using the generated value; and
evaluating the qualifier definition using the evaluated condition.

12. The computer-implemented method of claim 11,
wherein the external computer program comprises a user-defined computer program, and
wherein the user-defined computer program is defined independently from the computer program code definition of the qualifier definition.

13. The computer-implemented method of claim 12, wherein the user-defined computer program comprises a procedural language/structured query language function.

14. The computer-implemented method of claim 12, wherein the user-defined computer program comprises a user-defined function that generates a value for the custom parameter at run-time.

15. The computer-implemented method of claim 12, further comprising;
defining the user-defined computer program;
storing the user-defined computer program within the qualifier definition; and
linking the user-defined computer program with the custom parameter.

16. A system, comprising:
a qualifier definition selection module configured to select a qualifier definition that defines a qualifier; wherein the qualifier definition comprises a computer program code definition comprising one or more conditions;
a condition selection module configured to select a condition from the one or more conditions, wherein the condition comprises a parameter;
a parameter determination module configured to determine that the parameter is a custom parameter, wherein a custom parameter indicates that an external computer program is used to generate a value for the custom parameter;
an invocation module configured to invoke the external computer program to generate a value for the custom parameter;
a condition evaluation module configured to evaluate the condition using the generated value; and
an evaluation module configured to evaluate the qualifier definition using the evaluated condition.

17. The system of claim 16,
wherein the external computer program comprises a user-defined computer program, and
wherein the user-defined computer program is defined independently from the computer program code definition of the qualifier definition.

18. The system of claim 17, wherein the user-defined computer program comprises a procedural language/structured query language function.

19. The system of claim 17, wherein the user-defined computer program comprises a user-defined function that generates a value for the custom parameter at run-time.

20. The system of claim 17, further comprising;
a computer program definition module configured to define the user-defined computer program;
a storage module configured to store the user-defined computer program within the qualifier definition; and
a linking module configured to link the user-defined computer program with the custom parameter.
